(19) United States
(12) Patent Application Publication
(10) Pub. No.: US 2013/0015740 A1
(43) Pub. Date: Jan. 17, 2013

(54) Rotor Assembly for an Electric Machine

(71) Applicants: Bradley D. Chamberlin, Pendleton, IN (US); James J. Ramey, Fortville, IN (US)

(72) Inventors: Bradley D. Chamberlin, Pendleton, IN (US); James J. Ramey, Fortville, IN (US)

(73) Assignee: Remy Technologies, LLC, Pendleton, IN (US)

(21) Appl. No.: 13/181,160

(22) Filed: Jul. 12, 2011

(51) Int. Cl. H02K 16/00; H02K 1/22; H02K 15/00

(52) U.S. Cl. 310/114; 29/596; 310/261.1

(57) ABSTRACT

Some embodiments of the invention include a rotor assembly for an electric machine, including a rotor hub module. In some embodiments, the rotor hub module can include a body comprising a first and second group of apertures, an output shaft through a generally radially central portion of the body, and a support region along a generally radially outward portion of the body. In some embodiments a plurality of ribs can radially extend from a region of the body adjacent to the output shaft aperture to a region of the body adjacent to the support region. In some embodiments a plurality of rotor laminations can be operatively coupled to a portion of an outer diameter of the support region.

### BACKGROUND

Electric machines, often contained within a machine cavity of a housing, generally include a stator assembly and a rotor assembly. Some rotor assemblies can include rotor hubs, which can, at least partially, aid in electric machine operations by supporting portions of the rotor assembly and transmitting mechanical energy to and from an output shaft, depending on the application. Some rotor hubs can be manufactured from relatively heavy materials to ensure structural integrity during operation of the electric machine. As a result some rotor hubs can include relatively large masses and inertia values.

### SUMMARY

Some embodiments of the invention include a rotor assembly for an electric machine, including a rotor hub module. In some embodiments, the rotor hub module can include a body comprising a first and second group of apertures, an output shaft through a generally radially central portion of the body, and a support region along a generally radially outward portion of the body. In some embodiments a plurality of ribs can radially extend from a region of the body adjacent to the output shaft aperture to a region of the body adjacent to the support region. In some embodiments a plurality of rotor laminations can be operatively coupled to a portion of an outer diameter of the support region.

Some embodiments of the invention provide a rotor assembly for an electric machine, including a rotor hub module. In some embodiments, the rotor hub module can include a body comprising a plurality of low inertia regions, an output shaft aperture positioned generally radially centrally with respect to the low inertia regions, and a support region positioned generally radially outwardly with respect to the plurality of low inertia regions. In some embodiments a plurality of ribs can radially extend from a region of the body adjacent to the output shaft aperture to a region of the body adjacent to the support region. In some embodiments a plurality of rotor laminations can be operatively coupled to a portion of an outer diameter of the support region.

Some embodiments of the invention provide a method of assembling a rotor assembly. The method can include manufacturing a rotor hub module. In some embodiments, the rotor hub module can include a body and at least a portion of the body can include a plurality of low inertia regions, an output shaft aperture positioned generally radially centrally with respect to the low inertia regions, and a support region positioned generally radially outwardly with respect to the plurality of low inertia regions. Some embodiments can include positioning a plurality of ribs substantially between each of the plurality of low inertia regions and the ribs can extend radially outward from the output shaft to the support region. The method can include operatively coupling an output shaft to the rotor hub module and positioning a plurality of rotor laminations around a portion of an outer diameter of the support region.

### DESCRIPTION OF THE DRAWINGS

FIG. 1 is a cross-sectional view of an electric machine module according to one embodiment of the invention.

FIG. 2 is an isometric view of a rotor hub module according to one embodiment of the invention.

FIG. 3A is an end view of the rotor hub module of FIG. 2.

FIG. 3B is cross-sectional view of the rotor hub module of FIG. 3A along line “A-A.”

FIG. 4A is an isometric view of a rotor hub module according to one embodiment of the invention.

FIG. 4B is an isometric view of a rotor hub module according to one embodiment of the invention.

FIG. 5A is an end view of a rotor hub module according to one embodiment of the invention.

FIGS. 5B and 5C are cross-sectional views the rotor hub module of FIG. 5A along line “A-A,” according to some embodiments of the invention.

FIG. 6A is an isometric exploded view of a rotor hub module according to one embodiment of the invention.

FIG. 6B is an isometric view the rotor hub module of FIG. 6A.

FIG. 6C is an end view of the rotor hub module of FIG. 6B.

FIG. 7A is an isometric view of a rotor assembly according to one embodiment of the invention.

FIG. 7B is a cross-sectional view of the rotor assembly of FIG. 7A.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives that fall within the scope of embodiments of the invention.

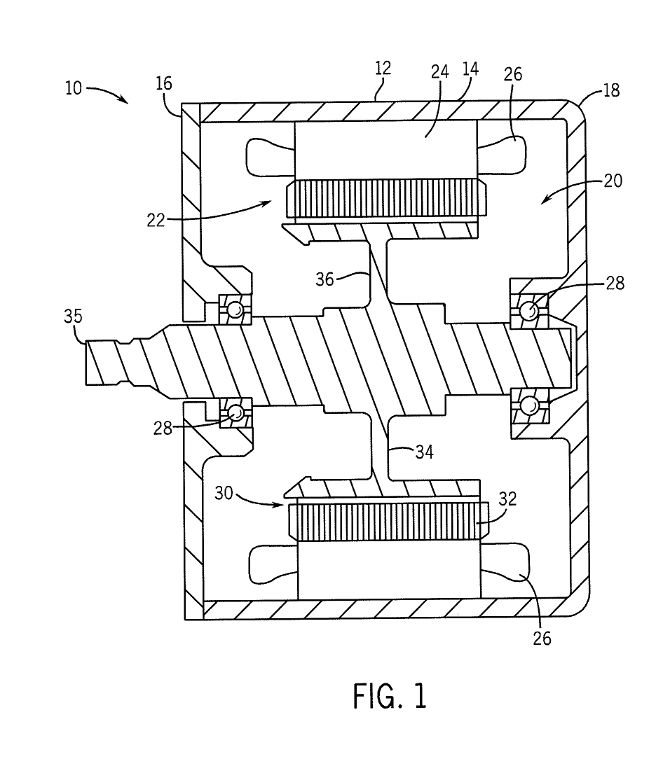

FIG. 1 illustrates an electric machine module 10 according to one embodiment of the invention. The module 10 can include a module housing 12 comprising a sleeve member 14, a first end cap 16, and a second end cap 18. An electric machine 20 can be housed within a machine cavity 22 at least partially within the module housing 12, including the sleeve member 14 and the end caps 16, 18. For example, the sleeve member 14 and the end caps 16, 18 can be coupled via conventional fasteners (not shown), or another suitable coupling method, to enclose at least a portion of the electric machine 20 within the machine cavity 22. In some embodiments the housing 12 can comprise a substantially cylindrical canister and a single end cap (not shown). Further, in some embodiments, the module housing 12, including the sleeve member 14 and the end caps 16, 18, can be fabricated from materials that can generally include thermally conductive properties, such as, but not limited to aluminum or other metals and materials capable of generally withstanding operating temperatures of the electric machine.

In some embodiments, the electric machine 20 can include a stator assembly 24 including stator end turns 26. Also, in some embodiments, the electric machine 20 can include bearings 28 and a rotor assembly 30. In some embodiments, the rotor assembly 30 can include a plurality of rotor laminations 32 substantially circumscribing at least a portion of a rotor hub module 34. Further, in some embodiments, the machine 20 can be disposed about an output shaft 35.

The electric machine 20 can be, without limitation, an electric motor, such as a hybrid electric motor, an electric generator, or a vehicle alternator. In one embodiment, the electric machine 20 can be a High Voltage Hairpin (HVH) electric motor or an interior permanent magnet electric motor for hybrid vehicle applications.

According to some embodiments of the invention, the rotor hub module 34 can be manufactured via different processes and can be manufactured of different materials. In some embodiments, the rotor hub module 34 can be manufactured by at least one of casting, forging, welding, brazing, molding, extruding, or other processes. Moreover, in some embodiments, the rotor hub module 34 can comprise steel, iron, aluminum, or other materials, such as other metals, polymeric materials, etc. By way of example only, in some embodiments, the module 34 can be cast from a metal-comprising material (e.g., steel) and can then be configured (e.g., machined) into a manufacturer and/or end user-desired configuration.

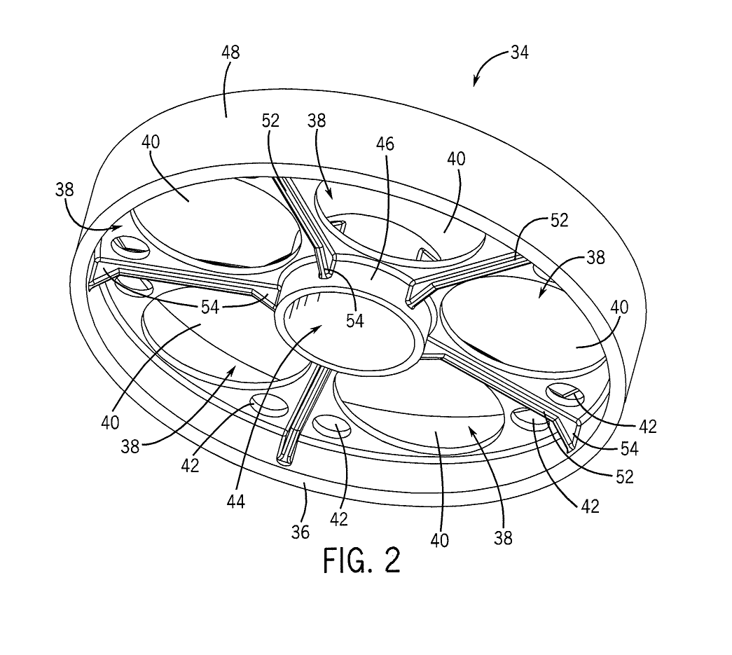

As shown in FIG. 2, in some embodiments, the rotor hub module 34 can include a body 36. In some embodiments, the body 36 can comprise a generally circular shape, however, in other embodiments, the body 36 can comprise other shapes including, but not limited to cylindrical, hemispherical, elliptical, or other regular or irregular polygonal shapes. Moreover, in some embodiments, the body 36 can comprise a plurality of regions. More specifically, in some embodiments, the body 36 can comprise a plurality of low inertia regions 38. In some embodiments, the body 36 can comprise five low inertia regions 38, although in other embodiments, the body 36 can include other numbers of low inertia regions 38.

In some embodiments, the body 36 can comprise at least one first aperture 40 and at least one second aperture 42. In some embodiments, the body 36 can comprise a plurality of first apertures 40 and a plurality of second apertures 42. For example, in some embodiments, each of the low inertia regions 38 can include a first aperture 40 and more than one second aperture 42. More specifically, in some embodiments, each of the low inertia regions 38 can include a first aperture 40 and at least two second apertures 42, as shown in FIGS. 2-6. Accordingly, in some embodiments, some low inertia regions 38 can comprise a ratio of about two second apertures 42 to about one first aperture 40, although other low inertia regions 38 can comprise different ratios, such as 1:1 or 3:1.

In some embodiments, the apertures 40, 42 can comprise different sizes relative to each other. For example, as shown in FIGS. 2-6, the first apertures 40 can each comprise a circumference that is greater than the circumference the second apertures 42. In some embodiments, the apertures 40, 42 can comprise other proportions such as the first apertures 40 comprising either a substantially similar circumference or a lesser circumference, relative to the second apertures 42. Moreover, in some embodiments, each of the first apertures 40 and the second apertures 42 can comprise different circumferences so that some of the first apertures 40 differ in size from other first apertures 40, and some of the second apertures 42 differ in size from other second apertures 42. Although the apertures 40, 42, as previously mentioned, include references to circular measurements (i.e., circumference), in some embodiments, the apertures 40, 42 can comprise other shapes, including, but not limited to elliptical, square, rectangular, regular or irregular polygonal, other shapes, or combinations thereof.

Additionally, in some embodiments, at least a portion of the body 36 immediately adjacent to the first and/or second apertures 40, 42 can comprise a reinforced configuration. For example, in some embodiments, at least a portion of the body 36 immediately adjacent to a portion of a perimeter of the first and/or second apertures 40, 42 can comprise a greater thickness relative to some of the other portions of the body 36. By way of example only, in some embodiments, a portion of the body substantially between at least a portion of the first and the second apertures 40, 42 can be at least partially thicker relative to other portions of the body 36. As a result, in some embodiments, at least a portion of these thicker regions can comprise an at least partially reinforced configuration.

In some embodiments, the body 36 can comprise at least one output shaft aperture 44. In some embodiments, the output shaft aperture 44 can be located generally centrally with respect to the module 34 and the body 36. For example, as shown in FIGS. 2-6, the output shaft aperture 44 can be positioned in a generally radially central portion of the body 36. In some embodiments, at least a portion of the output shaft 35 can be positioned through the output shaft aperture 44 to operatively couple together the output shaft 35 and the rotor hub module 34. Moreover, in some embodiments, the body 36 can comprise a collar 46 to aid in operatively coupling together the output shaft 35 and the rotor hub module 34.

Furthermore, in some embodiments, the coupling of the output shaft 35 and the body via the output shaft aperture 44 can comprise different manifestations. In some embodiments, the coupling can include the output shaft 35 comprising a substantially integral configuration with respect to the body 36. For example, in some embodiments, coupling can include the output shaft 35 can be formed so that it is substantially integral with the body 36 at the output shaft aperture 44.

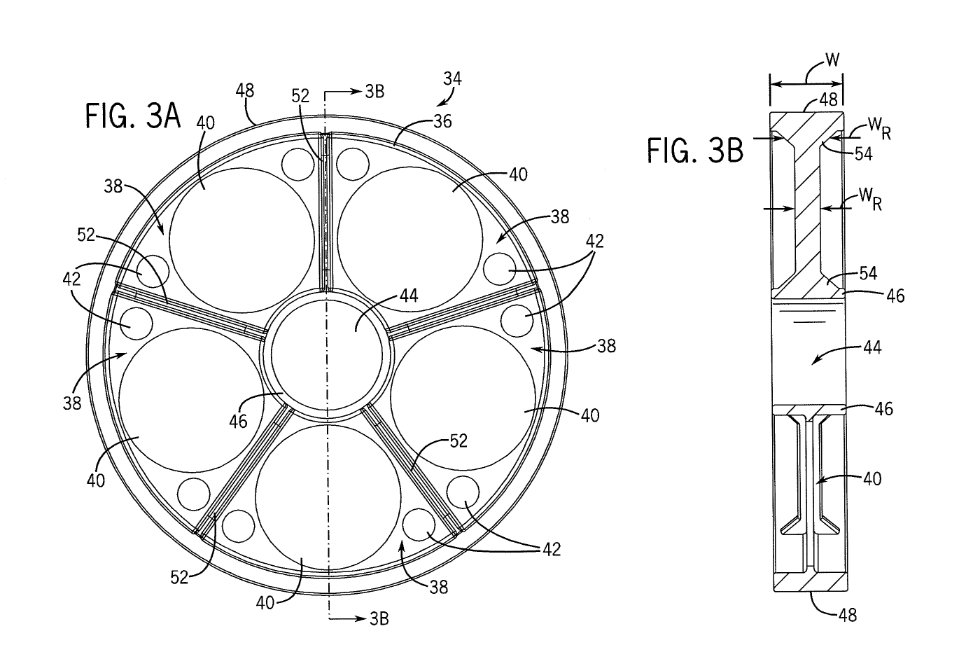

In some embodiments, the body 36 also can comprise a support region 48. In some embodiments, the support region 48 can be operatively coupled to the body 36 at a generally radially outward position. In other embodiments, the support region 48 can be substantially integral with the body 36. In some embodiments, the support region 48 can substantially circumscribe at least a portion of the body 36, as shown in FIGS. 2-7. Moreover, in some embodiments, the support region 48 can comprise a width, W, substantially equal to a width of the collar 46. In some embodiments, the first apertures 40 can extend from a region of the body 36 adjacent to the output shaft aperture 44 to a region adjacent to the support region 48, as shown in FIG. 3. As described in further detail below, in some embodiments, the support region 48 can at least partially support the plurality of rotor laminations 32.

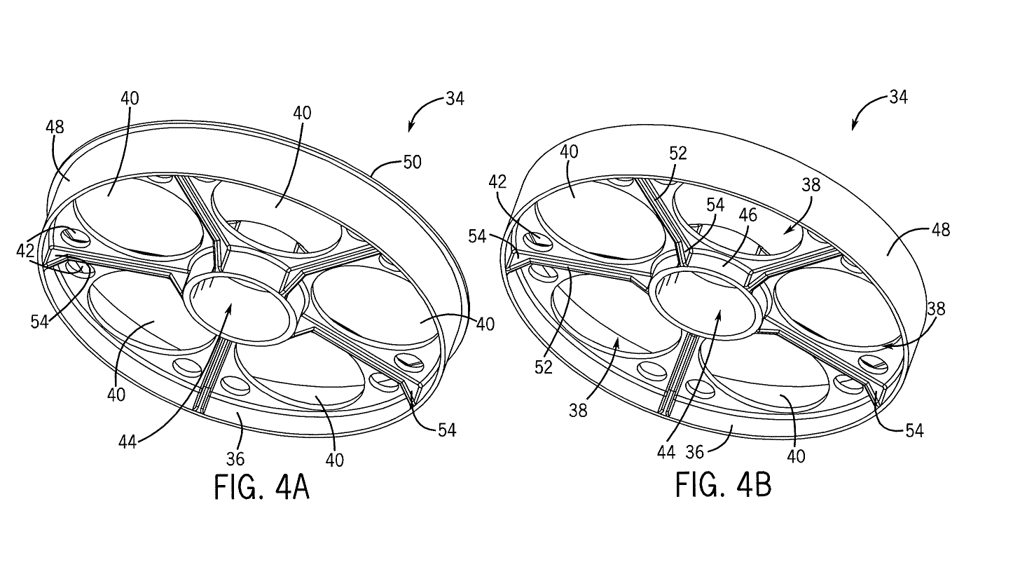

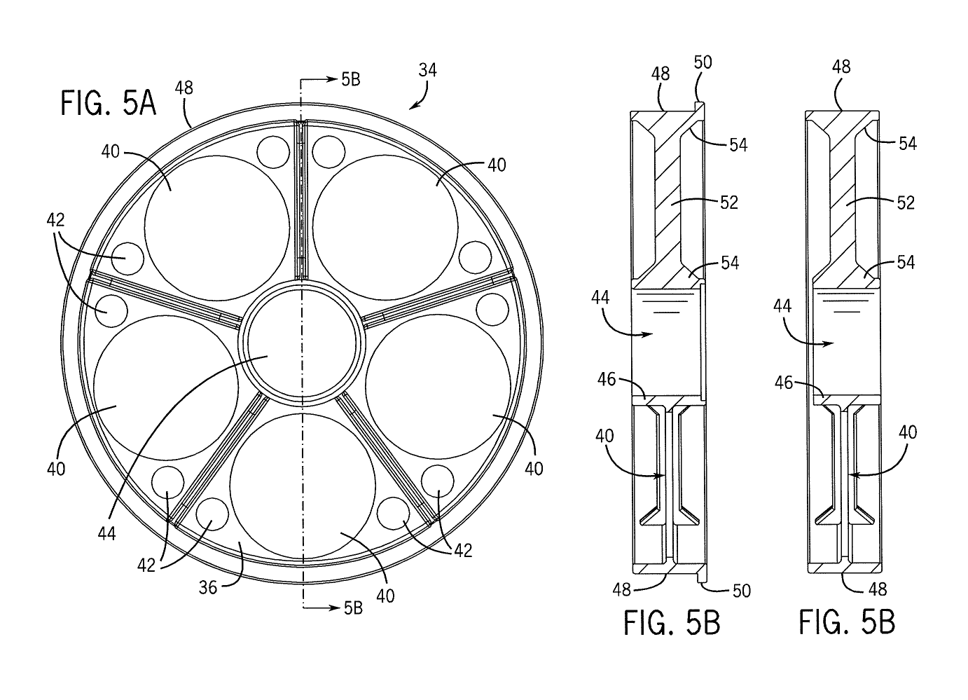

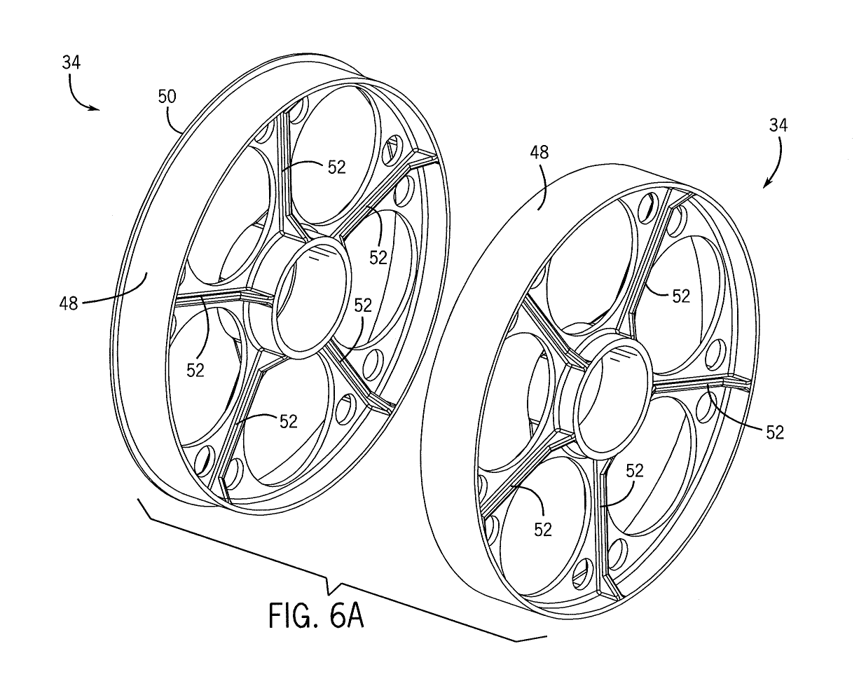

Further, in some embodiments, the body 36 can comprise a flange 50. Referring to FIG. 4, in some embodiments, the flange 50 can extend from the support region 48 in a generally radial direction. For example, in some embodiments, the flange 50 can extend from the support region 48 around substantially all of a perimeter of the support region 50. In other embodiments, the support region 48 can include one or more flanges 50 extending from portions of the support region 48 (i.e., one or more flanges 50 extending from portions of the support region 48). In some embodiments, the flange 50 can be formed after manufacture of the rotor hub module 34. For example, in some embodiments, the rotor hub module 34 can be manufactured to include a greater outer diameter than necessary for some applications. After manufacture, a portion of the support region 48 can be removed (i.e., machined) so that the flange 50 extends from the support region 48, as shown in FIGS. 4 and 5. In some embodiments, the support region 48 can be machined so that it can comprise a substantially planar outer diameter and no flange 50 extends from the support region 48. In other embodiments, the flange 50 can be operatively coupled to the rotor hub module 34 so that the flange 50 extends from a portion of the support region 48. As described below, the flange 50 can aid in coupling together the rotor hub module 34 and the plurality of rotor laminations 32.

In some embodiments, the body 36 and the low inertia regions 38 can include a plurality of ribs 52. In some embodiments, the ribs 52 can extend in a radial direction from the output shaft aperture 44 to the support region 48, as shown in FIGS. 2-7. In some embodiments, the ribs 52 can generally divide the body 36 into the low inertia regions 38. Furthermore, in some embodiments, the ribs 52 can provide structural strength to the rotor hub module 34.

As shown in FIGS. 3-6, in some embodiments, some portions of the ribs 52 can comprise extensions 54. In some embodiments, regions of the ribs 52 immediately adjacent to the output shaft aperture 44 and/or the support region 48 can include the extensions 54. More specifically, in some embodiments, the ribs 52 can include the extensions 54 so that a width of the ribs 52, W_{R}, can comprise different values, depending on the radial position, as shown in FIG. 3B. For example, in some embodiments, a region of the ribs 52 more radially inward (i.e., adjacent to the output shaft aperture 44) and/or more radially outward (i.e., adjacent to the support region 48) can include extensions 54 comprising a generally larger W_{R} compared to other regions of the ribs 52. In some embodiments, the width of the ribs 52 can gradually change to a width substantially similar to that of the support region 48 and/or output shaft aperture 44, and in other embodiments, the width can discretely change. In some embodiments of the invention, the extensions 54 can provide additional structural support for the rotor hub module 34.

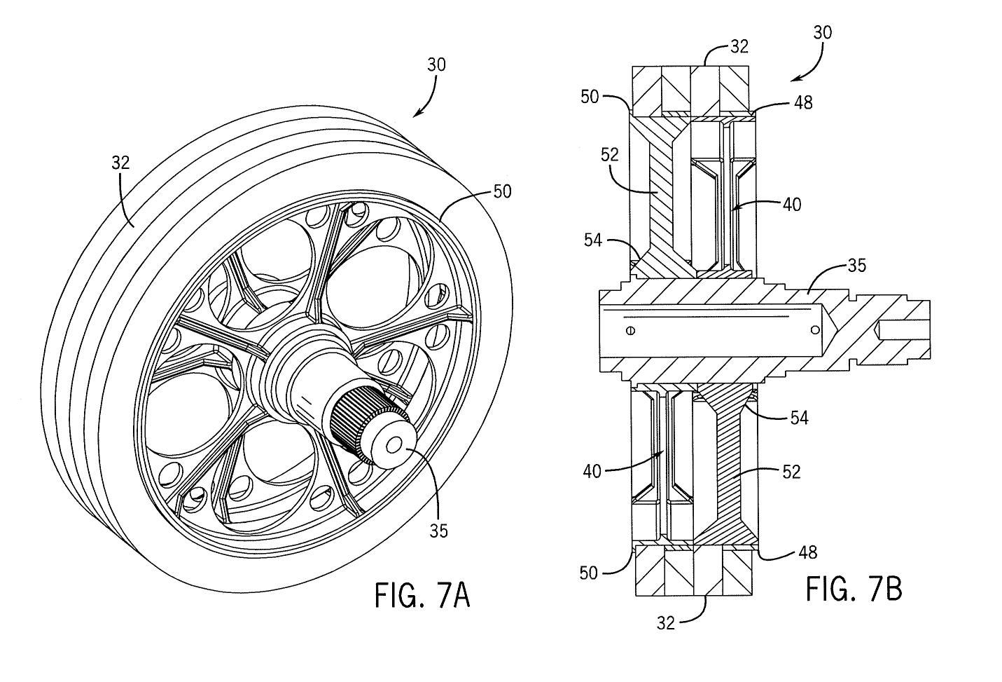

In some embodiments, the support region 48 can at least partially support a portion of the plurality of rotor laminations 32. As shown in FIG. 7, in some embodiments, at least some of the plurality of rotor laminations 32 can substantially circumscribe at least a portion of the rotor hub module 34. Moreover, in some embodiments, the at least one flange 50 can aid in retaining the rotor laminations 32. For example, in some embodiments, the rotor laminations 32 can be installed over the outer diameter of the support region 48 by axially moving them in a direction toward the flange 50. In some embodiments, once reaching the flange 50, the rotor laminations 32 can be substantially retained in position (i.e., the flange 50 can substantially prevent any further axial movement). In some embodiments, after installing the rotor laminations 32, the rotor hub module 34 and the rotor laminations 32 can be operatively coupled together. For example, in some embodiments, the two elements can be welded (i.e., spot welded, laser welded, resistance welded, etc.), brazed, coupled together using conventional fasteners or adhesives, staked, or other similar coupling methods. In some embodiments, the ribs 52 can provide some radial support for the support region 48 and the rotor laminations 32.

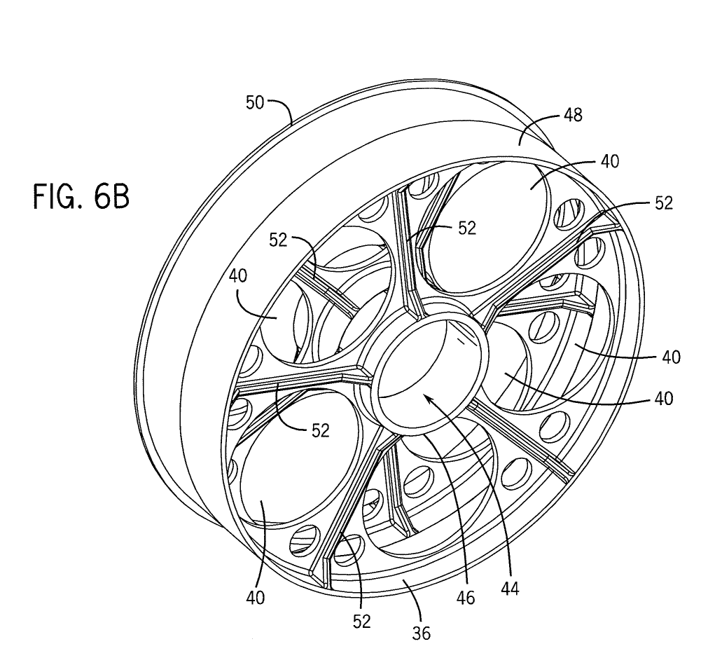

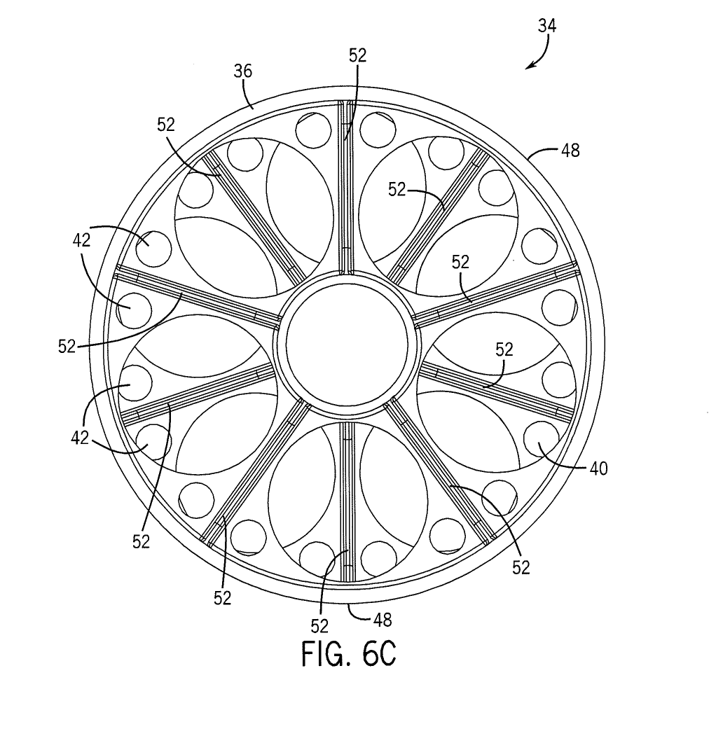

As shown in FIGS. 6 and 7, in some embodiments, the rotor assembly 30 can comprise multiple rotor hub modules 34. In some embodiments, multiple rotor hub modules 34 can be operatively coupled together to extend an axial length of the rotor assembly 30 to meet manufacturer and/or end user requirements. For example, as shown in FIG. 6A-6C, in some embodiments, two rotor hub modules 34 can be coupled together to meet application requirements. In other embodiments, more than two rotor hub modules 34 can be coupled together, depending on end use applications. In some embodiments, at least one of the rotor hub modules 34 can comprise a flange 50 to aid in positioning and retaining the rotor laminations 32, as previously mentioned. For example, in some embodiments, at least one of the outermost axially positioned rotor hub modules 34 can comprise a flange 50 and at least a portion of the remaining rotor hub modules 34 can comprise a substantially planar outer diameter of the support region 48 to aid in positioning the rotor laminations 32.

In some embodiments, the rotor hub modules 34 can be coupled together before and/or after positioning the rotor laminations 32. For example, in some embodiments, the rotor laminations 32 can be positioned along the outer diameter of the support region 48 of a first rotor hub module 34 and then the rotor laminations 32 and the module 34 can be coupled together. Then, a second rotor hub module 34 can be coupled to the first rotor hub module 34 and further rotor laminations 32 can be position along the outer diameter of the support region 48 of the second rotor hub module 34 and then the laminations 32 can be coupled to the module 34. In some embodiments, this process can be repeated as many times as necessary until the rotor assembly 30 reaches a desired axial length. In some embodiments, a plurality of rotor hub modules 34 can be operatively coupled together and then some or all of rotor laminations 32 can positioned along the outer diameter of the support region 48 of the combined rotor hub module 34 and coupled together.

In some embodiments, when coupling together the rotor hub modules 34, the modules 34 can be offset relative to each other, as shown in FIGS. 6A-6C. For example, in some embodiments, each of the rotor hub modules 34 can comprise a substantially similar configuration. In some embodiments, at least partially depending on the number of low inertia regions 38 and ribs 52, each rotor hub module 34 coupled to a first rotor hub module 34 can be rotated in either a clockwise or a counter-clockwise direction. In some embodiments, the second rotor hub module 34 can be rotated between about 20 and about 60 degrees relative to the first rotor hub module 34, although the second rotor hub module 34 can be rotated other amounts as well. For example, in some embodiments, the second rotor hub module 34 can be offset by approximately 36 degrees relative to the first rotor hub module 34. As a result, in some embodiments, the ribs 52 of the second rotor hub module 34 can be generally aligned with portions of the first apertures 40 and/or second apertures 42 of the first rotor hub module 34, or vice versa. Moreover, in some embodiments, each successive rotor hub module 34 operatively coupled to the rotor assembly 30 can be offset in a similar manner. In some embodiments, by substantially aligning the ribs 52 of one of the modules 34 with the apertures 40, 42 of another module 34, the structural strength of the rotor assembly 30 can be enhanced.

Many conventional rotor hubs can be manufactured from materials including solid steel or other metals. As a result, some conventional rotor hubs can include a relatively large mass and relative large inertia values. Some embodiments of the invention can include a reduction in both mass and inertia because of a decrease in materials used in by including the apertures 40, 42. Also, relative to some convention rotor hubs, some embodiments of the invention can comprise a reduction in mass by about 17% and a reduction in inertia by about 13%. By way of example only, in some embodiments, the apertures 40, 42 can be configured and arranged to maximize the amount of mass removed while still retaining the necessary structural stability for the operating electric machine 20. Accordingly, in some embodiments, the first apertures 40 can comprise a significant portion of the low inertia region 38 and the second apertures 42 can comprise a significant portion of the low inertia region 38 not comprised by the first apertures 40. As a result, some embodiments of the invention can consume less energy during machine 20 operations because less energy is necessary to move the reduced mass of the rotor hub module 34. Further, because of a reduction in inertia, after substantially stopping operation of the machine 20, the rotor assembly 30 can come to a stop sooner.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

1. An electric machine comprising:
a rotor hub module including
a body, a first group of apertures and a second group of apertures positioned through portions of the body,
an output shaft aperture positioned through a generally radially central portion of the body,
a support region positioned at a generally radially outward portion of the body, and
a plurality of ribs radially extending from a region of the body adjacent to the output shaft aperture to a region of the body adjacent to the support region; and
a plurality of rotor laminations operatively coupled to at least a portion of an outer diameter of the support region.

2. The electric machine of claim 1 and further comprising a flange extending from the outer diameter of the support region.

3. The electric machine of claim 1 and further comprising an output shaft positioned through a portion of the output shaft aperture, the output shaft operatively coupled to the rotor hub.

4. The electric machine of claim 1 and further comprising a stator assembly substantially circumscribing a portion of the rotor assembly.

5. The electric machine of claim 1 and further comprising a plurality of rotor hub modules operatively coupled together.

6. The electric machine of claim 5, wherein the plurality of rotor hub modules comprises a first rotor hub module and a second rotor hub module, and wherein the first and the second rotor hub modules are coupled together so that the second rotor hub module is rotated by between about 20 and about 60 degrees relative to the first rotor hub module.

7. The electric machine of claim 6, wherein one of the first rotor hub module and the second rotor hub module comprises a flange extending from the outer diameter of the support region.

8. The electric machine of claim 1, wherein the ratio of a number of the second apertures to a number of the first apertures is about two to one.

9. The electric machine of claim 1, wherein the rotor hub module comprises one of a forged metal and a cast metal.

10. The electric machine of claim 1, wherein at least some of the plurality of ribs comprise extensions adjacent to the output shaft aperture and the support region.

11. An electric machine module comprising:
a rotor hub module including
a body, at least a portion of the body including a plurality of low inertia regions, an output shaft aperture positioned generally radially centrally with respect to the low inertia regions, and a support region positioned generally radially outwardly with respect to the plurality of low inertia regions, and
a plurality of ribs positioned substantially between each of the plurality of low inertia regions and extending in a generally radial direction;
a plurality of rotor laminations substantially circumscribing a portion of the rotor hub module; and
an output shaft operatively coupled to the rotor hub module at the output shaft aperture.

12. The rotor assembly of claim 11, and further comprising a flange extending from the support region.

13. The rotor assembly of claim 11, wherein each of the low inertia regions comprises at least one first aperture and at least one second aperture.

14. The rotor assembly of claim 13, wherein each of the plurality of ribs is positioned substantially between each of the first apertures.

15. The rotor assembly of claim 11, wherein at least some of the plurality of ribs comprise extensions adjacent to the output shaft aperture and the support region.

16. The rotor assembly of claim 11, and further comprising a plurality of rotor hub modules operatively coupled together.

17. The rotor assembly of claim 16, wherein the plurality of rotor hub modules comprises a first rotor hub module and a second rotor hub module, and wherein the first and the second rotor hub modules are coupled together so that the second rotor hub module is rotated by between about 20 and about 60 degrees relative to the first rotor hub module.

18. The rotor assembly of claim 11, wherein the rotor hub module comprises one of a forged metal and a cast metal.

19. A method of assembling a rotor assembly, the method comprising:
manufacturing a rotor hub module, the rotor hub module including a body, at least a portion of the body including a plurality of low inertia regions, an output shaft aperture positioned generally radially centrally with respect to the low inertia regions, and a support region positioned generally radially outwardly with respect to the plurality of low inertia regions, and
positioning a plurality of ribs substantially between each of the plurality of low inertia regions and extending in a generally radial direction;
operatively coupling an output shaft to the rotor hub module so that a portion of the output shaft extends through the output shaft aperture; and
positioning a plurality of rotor laminations around a portion of an outer diameter of the support region.

20. The method of claim 19 and further comprising providing a flange extending from the outer diameter of the surface region.
